(19) United States
(12) Patent Application Publication
(10) Pub. No.: US 2018/0245730 A1
(43) Pub. Date: Aug. 30, 2018

(54) RODENT STOPPER SYSTEM

(71) Applicant: Lyle Yaeger, Winchester, OR (US)

(72) Inventor: Lyle Yaeger, Winchester, OR (US)

(21) Appl. No.: 15/907,236

(22) Filed: Feb. 27, 2018

Related U.S. Application Data
(60) Provisional application No. 62/464,105, filed on Feb. 27, 2017.

(51) Int. Cl. F16L 57/00

(52) U.S. Cl. CPC F16L 57/00

(57) ABSTRACT

A rodent stopper system including several embodiments for protecting residential and commercial water pipes from rodent damage. A first embodiment includes a protective sleeve applied to pipes during a manufacturing process. The second embodiment includes an elongated sleeve with a fastener which may be attached to existing pipes in homes and businesses. The third embodiment includes a tape-member configured to be wrapped and installed around a pipe. Each embodiment includes a reinforced mesh which is a rodent-resistant barrier and prevents the pipe from being chewed by a rodent.

### CROSS REFERENCE TO RELATED APPLICATION

The present application is related to and claims priority to U.S. Provisional Patent Application No. 62/464,105 filed Feb. 27, 2017, which is incorporated by reference herein in its entirety.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### 1. Field of the Invention

The present invention relates generally to the field of rodent resistant pipes and more specifically relates to pipe coatings and sleeves for use in rodent deterrence.

### 2. Description of Related Art

Most rodent pests are small animals with robust bodies, short limbs, and long tails. Rodents are known for continuously growing, razor-sharp incisors. Large amounts of poison may be used to control rats and mice from living in people's homes or building structures. Rodents seek out water to try and flush the ingested poison which causes them to chew and claw at waterlines, causing significant leaks, flooding, and even structural damage to homes and businesses which is not desirable. In such situations, homeowners and business owners are typically forced to schedule emergency plumbing visits, which can be expensive and a nuisance. A suitable solution is desired.

U.S. Pub. No. 2011/0005156 to Timothy John Laufer relates to a damage prevention housing for a roof pipe and related methods. The described damage prevention housing for a roof pipe and related methods includes a damage prevention housing for a roof pipe may include a hollow body having an interior dimensioned to enclose a roof pipe on a roof, the hollow body having an open proximal end suitable for positioning over the roof pipe and a partially closed distal end dimensioned to preclude access by rodents but allow movement of gases therethrough. The hollow body may further include an aperture positioned adjacent to the proximal end for allowing liquids and gases to move through the aperture and a fastener for securing the hollow body in a fixed position relative to the roof pipe and the roof.

### BRIEF SUMMARY OF THE INVENTION

In view of the foregoing disadvantages inherent in the known rodent resistant pipes art, the present disclosure provides a novel rodent stopper system. The general purpose of the present disclosure, which will be described subsequently in greater detail, is to provide a pipe wrap insulation sleeve for protecting a pipe from rodent damage. The device may be used for residential or commercial homes and buildings. The rodent stopper may reduce rodent damage and reduce repair costs.

A rodent stopper system is disclosed herein. The rodent stopper system includes a sleeve that may be applied to a pipe and prevent (deter) rodents from damaging pipes. In one embodiment, rodent stopper system comprises an elongated sleeve configured to be installed around a pipe to conceal the pipe. The elongated sleeve comprises a reinforced mesh. The elongated sleeve is pre-applied during a manufacturing process prior to a pipe-installation. In another embodiment, the rodent stopper system includes an elongated sleeve having a rectangular body, and a fastener extending along a length of the body. The elongated sleeve is configured to be folded and fastened into a cylindrical shape. The elongated sleeve is configured to be wrapped and installed around a pipe to conceal the pipe.

In yet another embodiment, the rodent stopper system includes a tape-member having a body including a length. The tape-member is configured to be wrapped and installed around a pipe. The tape-member comprises a reinforced mesh integral to the body. The reinforced mesh of the body provides a rodent-resistant barrier and prevents the pipe from being chewed by a rodent. The tape-member is configured to be applied directly to a 90-degree joints and T-shaped junctions of pipes or pipes that do not require insulation. The tape-member is configured to be adhesively secured to the pipe. The tape-member is configured to be applied to joints and junctions of the pipes.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a rodent stopper system, constructed and operative according to the teachings of the present disclosure.

FIG. 1 is a perspective view of the rodent stopper system during an ‘in-use’ condition, according to an embodiment of the disclosure.

FIG. 2 is a perspective view of the rodent stopper system of FIG. 1, according to an embodiment of the present disclosure.

FIG. 3 is a perspective view of the rodent stopper system of FIG. 1, according to another embodiment of the present disclosure.

FIG. 4 is a perspective view of the rodent stopper system of FIG. 1, according to another embodiment of the present disclosure.

FIG. 5 is another perspective view of the rodent stopper system of FIG. 1, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to rodent resistant pipes and more particularly to a rodent stopper system as used to improve the pipe integrity over the lifespan of the pipe.

Generally, the present invention stops (deters) rodents and mice from chewing through water lines. This helps prevent water leaks and structural damage to homes and business properties. It reduces staggering repair costs. It saves a considerable amount of time and frustration. The present invention can be offered in three different styles to accommodate use on both existing pipe constructions and newly manufactured pipes. As designed, rodent stopper system deters rodents from chewing through water pipes.

This product may comprise an insulated sleeve for residential and commercial water pipes. The sleeve can be offered in one of three versions. The first version can include a protective sleeve applied to pipe insulation during the manufacturing process. It can be made from stainless steel or copper, coated in plastic or other suitable material. Additionally, it can be offered in common sizes of up to 6′ in length and 0.5″-6″ in diameter. The second version can include a protective sleeve for non-insulated pipe applications, with either a water-resistant zipper seal or hook-and-loop fasteners, designed to attach to existing pipes in homes and businesses. This version can be made from the same material and feature the same dimensions as the first version. Finally, the third version of sleeve can be made from duct-tape material with built-in mesh material and can be applied to the 90-degree joints and T-shaped junctions of pipes or pipes that do not require insulation. This may also be applied to any seams or penetration where the mesh does not cover. The exact specifications may vary upon manufacturing.

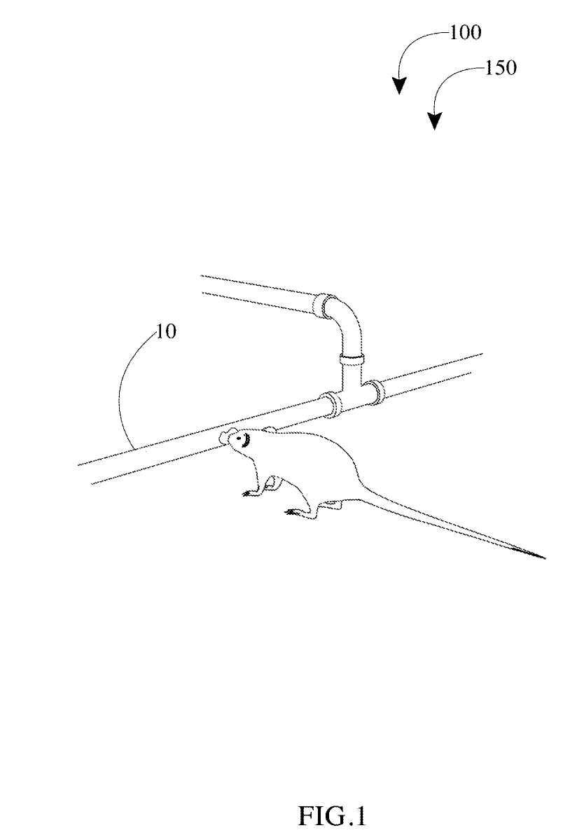

Referring now more specifically to the drawings by numerals of reference, there is shown in FIGS. 1-5, various views of a rodent stopper system 100. FIG. 1 shows a rodent stopper system 100 during an ‘in-use’ condition 150, according to an embodiment of the present disclosure. As illustrated, the rodent stopper system 100 may include various embodiments for protecting pipes 10 from rodent damage.

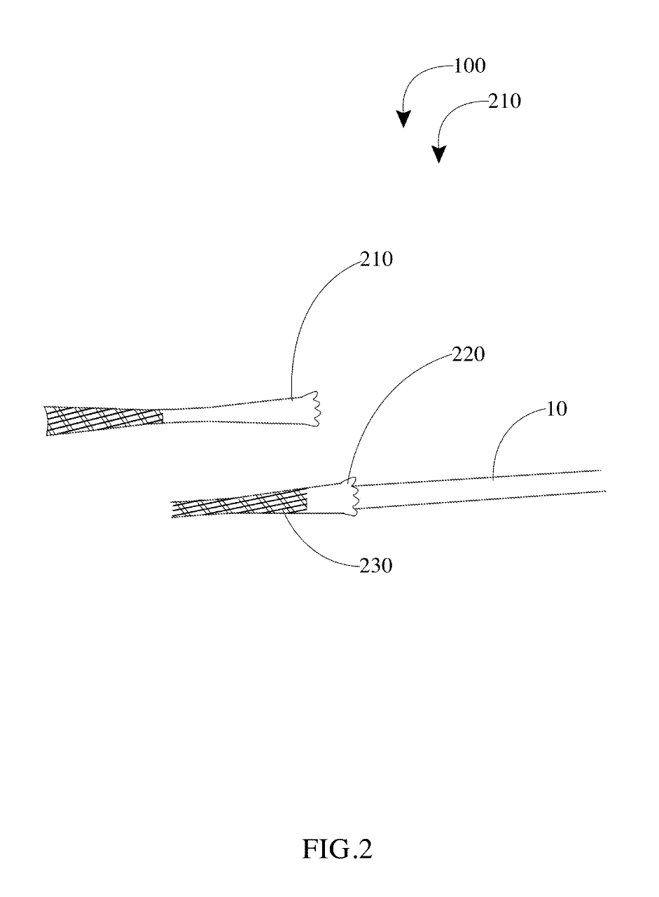

FIG. 2 shows a perspective view of the rodent stopper system 100 of FIG. 1, according to one embodiment of the present disclosure. As above, the rodent stopper system 100 may include an elongated sleeve 210. The elongated sleeve 210 comprises a cylindrical body 220 configured to be installed around a pipe 10 to conceal the pipe 10. The elongated sleeve 210 comprises a reinforced mesh 230. The reinforced mesh 230 of the cylindrical body 220 is a rodent-resistant barrier and prevents (deters the rodent from chewing) the pipe 10 from being chewed. The elongated sleeve 210 is pre-applied to a pipe 10 during a manufacturing process prior to a pipe-installation. The reinforced mesh 230 comprises a metal material with a plastic coating. The elongated sleeve 210 is semi-flexible and configured to contour to an outer surface of the pipe 10. The elongated sleeve 210 comprises a length of approximately 6-feet and a diameter ranging from 0.5 inches and 6 inches.

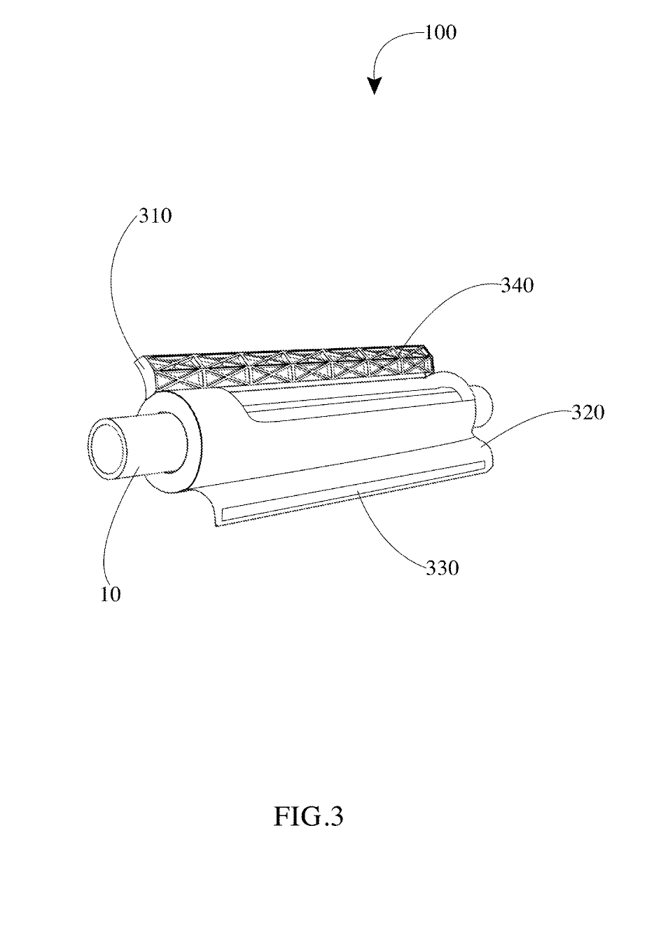

Referring now to FIG. 3 showing a perspective view of the rodent stopper system 100 of FIG. 1, according to another embodiment of the present disclosure. As above, the rodent stopper system 100 may include an elongated sleeve 310 having a rectangular body 320 (other shapes may be used), and a fastener 330 extending along a length of the body 320. The elongated sleeve 310 is configured to be folded and fastened into a cylindrical shape. The elongated sleeve 310 is configured to be wrapped and installed around a pipe 10 to conceal the pipe 10. The elongated sleeve 310 comprises a reinforced mesh 340. The reinforced mesh 340 of the body 320 is a rodent-resistant barrier and prevents the pipe from being chewed by a rodent.

In this embodiment, the elongated sleeve 310 is applied to a non-insulated pipe 10. The pipe 10 is pre-installed and the elongated sleeve 310 is user applied to the existing pipes 10 of residential and commercial pipelines. The fastener 330 may include a water-resistant zipping fastener seal or a hook and loop fastener having a male-portion and a female-portion configured to mate and secure the elongated sleeve 310 around the pipe. The elongated sleeve 310 is semi-flexible and configured to contour to an outer surface of the pipe 10. In a preferred embodiment, the elongated sleeve 310 comprises a length of approximately 6-feet, a minimum diameter of 0.5 inches, and a maximum diameter of 6 inches.

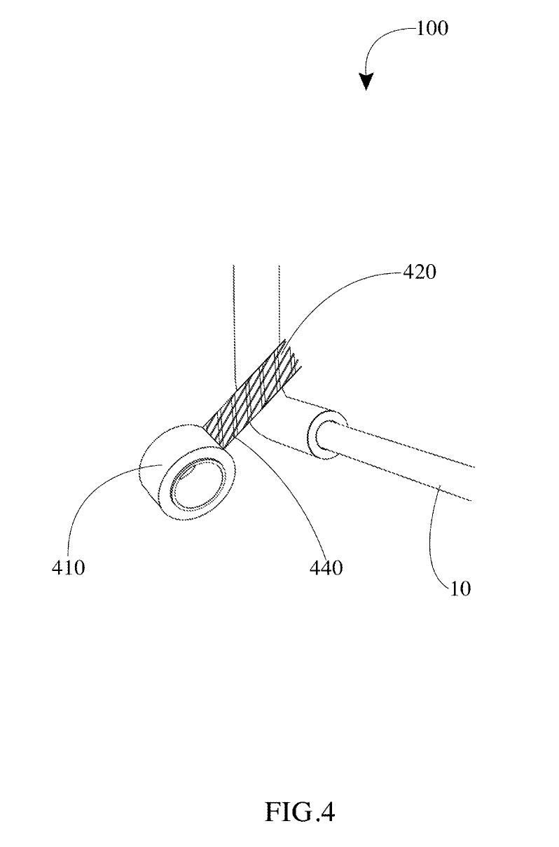

FIG. 4 shows a perspective view of the rodent stopper system 100 of FIG. 1, according to another embodiment of the present disclosure. As above, the rodent stopper system 100 may include includes a tape-member 410 having a duct-tape like body 420 including a length. The tape-member 410 is configured to be wrapped and installed around a pipe 10. The tape-member 410 comprises a reinforced mesh 440 integral to the body 420. The reinforced mesh 440 of the body 420 provides a rodent-resistant barrier and prevents the pipe 10 from being chewed by a rodent. The tape-member 410 is configured to be applied directly to an outer surface of the pipe 10. The tape-member 410 is configured to be adhesively secured to the pipe 10. The tape-member 410 is configured to be applied to joints and junctions of non-insulated pipes 10. With this embodiment, the pipe 10 is pre-installed and the tape-member 410 is user applied to an existing pipe 10 of a residential or commercial pipeline.

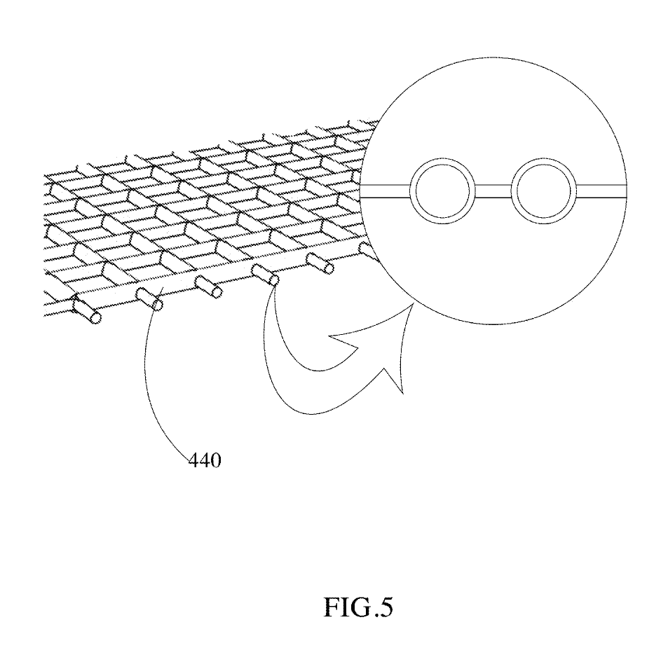

Referring now to FIG. 5 showing a perspective view of the rodent stopper system 100 of FIG. 1, according to an embodiment of the present disclosure. As above, the rodent stopper system 100 may include a reinforced mesh 440 comprising a series of woven metal-material sections. The reinforced mesh 440 is a rodent-resistant barrier and prevents the pipe 10 from being chewed by a rodent when applied to a pipe 10.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A rodent stopper system comprising:
an elongated sleeve;
wherein said elongated sleeve comprises a cylindrical body configured to be installed around a pipe to conceal said pipe;
wherein said elongated sleeve comprises a reinforced mesh; and
wherein said reinforced mesh of said cylindrical body is a rodent-resistant barrier and prevents said pipe from being chewed by a rodent.

2. The rodent stopper system of claim 1, wherein said elongated sleeve is pre-applied during a manufacturing process prior to a pipe-installation.

3. The rodent stopper system of claim 1, wherein said reinforced mesh comprises a metal material with a plastic coating.

4. The rodent stopper system of claim 1, wherein said elongated sleeve is semi-flexible and configured to contour to an outer surface of said pipe.

5. The rodent stopper system of claim 1, wherein said elongated sleeve comprises a length of approximately 6-feet.

6. The rodent stopper system of claim 5, wherein said elongated sleeve comprises a minimum diameter of 0.5 inches and a maximum diameter of 6 inches.

7. A rodent stopper system comprising:
an elongated sleeve having;
a rectangular body; and
a fastener extending along a length of said body;
wherein said elongated sleeve is configured to be folded and fastened into a cylindrical shape;
wherein said elongated sleeve is configured to be wrapped and installed around a pipe to conceal said pipe;
wherein said elongated sleeve comprises a reinforced mesh; and
wherein said reinforced mesh of said body is a rodent-resistant barrier and prevents said pipe from being chewed by a rodent.

8. The rodent stopper system of claim 7, wherein said elongated sleeve is applied to a non-insulated pipe.

9. The rodent stopper system of claim 7, wherein said pipe is pre-installed and said elongated sleeve is user applied.

10. The rodent stopper system of claim 7, wherein said fastener comprises a water-resistant zipping fastener seal.

11. The rodent stopper system of claim 7, wherein said fastener comprises a hook and loop fastener having a male-portion and a female-portion configured to mate and secure said elongated sleeve around said pipe.

12. The rodent stopper system of claim 11, wherein said elongated sleeve is semi-flexible and configured to contour to an outer surface of said pipe.

13. The rodent stopper system of claim 7, wherein said wherein said elongated sleeve comprises a length of approximately 6-feet

14. The rodent stopper system of claim 13, wherein said elongated sleeve comprises a minimum diameter of 0.5 inches and a maximum diameter of 6 inches.

15. A rodent stopper system comprising:
a tape-member having;
a body including;
a length;
wherein said tape-member is configured to be wrapped and installed around a pipe;
wherein said tape-member comprises a reinforced mesh integral to said body; and
wherein said reinforced mesh of said body provides a rodent-resistant barrier and prevents said pipe from being chewed by a rodent.

16. The rodent stopper system of claim 15, wherein said tape-member is configured to be applied directly to an outer surface of said pipe.

17. The rodent stopper system of claim 16, wherein said tape-member is configured to be adhesively secured to said pipe.

18. The rodent stopper system of claim 17, wherein said tape-member is configured to be applied to joints and junctions of said pipes.

19. The rodent stopper system of claim 15, wherein said pipe is non-insulated.

20. The rodent stopper system of claim 19, wherein said pipe is pre-installed and said tape-member is user applied.
